(19) United States
(12) Patent Application Publication
(10) Pub. No.: US 2006/0112973 A1
(43) Pub. Date: Jun. 1, 2006

(54) Method and apparatus for substrate processing

(75) Inventor: Shuzo Nagami, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd

(21) Appl. No.: 11/284,716

(22) Filed: Nov. 22, 2005

(30) Foreign Application Priority Data
Nov. 29, 2004 (JP) JP2004-344026

(51) Int. Cl. B08B 3/00

(52) U.S. Cl. 134/26; 134/34; 134/94.1; 134/95.2; 134/135

(57) ABSTRACT

A substrate processing apparatus admits nitrogen gas into a casing, while immersing a substrate in deionized water stored in a processing tank. Oxygen and water vapor within the casing are replaced with nitrogen gas and then removed. Subsequently, the substrate processing apparatus supplies IPA vapor toward substrates, while lifting the substrates from deionized water. Since IPA vapor is blown directly on the substrates, IPA condenses efficiently on the surfaces of the substrates. Therefore, if the concentration of IPA vapor is lowered, there is no fear of the drying performance of the substrates from deteriorating. Additionally, lowering the concentration of IPA vapor can prevent dissolution of a resist film formed on the surfaces of the substrates.

### BACKGROUND OF THE INVENTION

1. Field of the Invention

The present invention relates to a substrate processing method and a substrate processing apparatus that perform cleaning processing and drying processing of substrates such as semiconductor substrates, glass substrates for liquid crystal display, and glass substrates for photo mask.

2. Description of the Background Art

Traditionally, substrate processing apparatuses perform cleaning processing and drying processing of chemical-treated substrates. In particular, the recent substrate processing apparatuses perform substrate cleaning processing with deionized water, and then perform substrate drying processing with IPA (isopropyl alcohol) that is organic solvent.

In such a substrate processing apparatus, substrates are first immersed in deionized water stored in a processing tank within a sealed casing, thereby cleaning the substrates. Subsequently, the substrate processing apparatus lifts the substrates from the deionized water, and supplies IPA vapor around the lifted substrates. The apparatus then depressurizes the interior of the casing. The IPA vapor is condensed on the substrates surfaces and replaced with the deionized water that attaches to the substrates surfaces. The IPA that condenses on the substrates surfaces vaporizes together with the deionized water, thereby drying the substrates surfaces.

However, when a resist film is being formed on the substrates surfaces, namely, when the substrates surfaces are hydrophilic, the supply of organic solvent such as IPA may result in dissolution of the resist film on the substrates surfaces. Hence, if resist-applied substrates are processed by the above method, a resist film on the substrates surfaces may dissolve due to the IPA that condenses on the substrates surfaces.

Lowering the concentration of IPA vapor supplied into the casing may suppress the dissolution of the resist film to some extent. However, lowering the concentration of IPA vapor lowers the drying performance of the substrates, so that poor drying is apt to occur.

### SUMMARY OF THE INVENTION

The present invention is directed to a substrate processing method that performs substrate cleaning and drying in the interior of a processing chamber.

According to this invention, the substrate processing method comprises the following steps of: (a) admitting inert gas to a central space and an upper space within a processing chamber, while immersing a substrate in deionized water stored in a processing tank; and (b) blowing organic solvent vapor on a substrate, while lifting a substrate from deionized water.

During immersion of a substrate in deionized water, the processing chamber is filled with inert gas, and the unnecessary oxygen and vapor are removed to the exterior of the processing chamber. Then, the organic solvent vapor is directly blown on the substrate that is being lifted from the deionized water, so that the organic solvent condenses efficiently on the substrate surface. Therefore, if the concentration of organic solvent is lowered, there is no fear of drying performance deterioration. Further, lowering the concentration of organic solvent can prevent dissolution of a resist film formed on the substrate surface.

Preferably, in the step (b), organic solvent vapor is blown on a substrate from the right and left of the substrate.

This enables the organic solvent vapor to be blown efficiently on the substrate from the closest position to the substrate. This also eliminates the possibility of directly applying the organic solvent vapor onto the liquid level of deionized water.

Preferably, in the step (b), organic solvent vapor is blown directly on a contact area between a substrate and a holing member that holds the substrate.

This permits satisfactory removal of droplets attached to the contact area between the substrate and the holding member, from which it is hard to remove deionized water.

Preferably, the inert gas admitted in the step (b) is heated inert gas.

This enables thermal energy to be stored in a substrate, thereby facilitating vaporization of organic solvent and deionized water.

Preferably, after the step (b), inert gas is admitted into a central space and an upper space of the processing chamber.

The organic solvent vapor and deionized water that remain on the substrate surface can be vaporized.

The present invention is also directed to a substrate processing apparatus that performs substrate cleaning and drying in the interior of a processing chamber.

Accordingly, an object of the present invention is to provide a technique capable of suppressing dissolution of a resist film formed on the surface of a substrate, without deteriorating drying performance, in a substrate processing with organic solvent.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a general arrangement of a substrate processing apparatus;

FIG. 2 is a longitudinal section of a multifunctional processing part, the section being taken along the plane parallel to a substrate;

FIG. 3 is a longitudinal section of the multifunctional processing part, the section being taken along the plane perpendicular to a substrate;

FIG. 4 is a schematic diagram showing a construction of pipes and the like that are related to the multifunctional processing part;

FIGS. 5 to 10 are diagrams showing situations of processing in the multifunctional processing part; and

FIG. 11 is a diagram showing a mounting height of a gas-discharge pipe of a first gas-discharge part.

### DESCRIPTION OF THE PREFERRED EMBODIMENTS

Preferred embodiments of the present invention will be described with reference to the accompanying drawings.

<1. General Arrangement of Substrate Processing Apparatus 1>

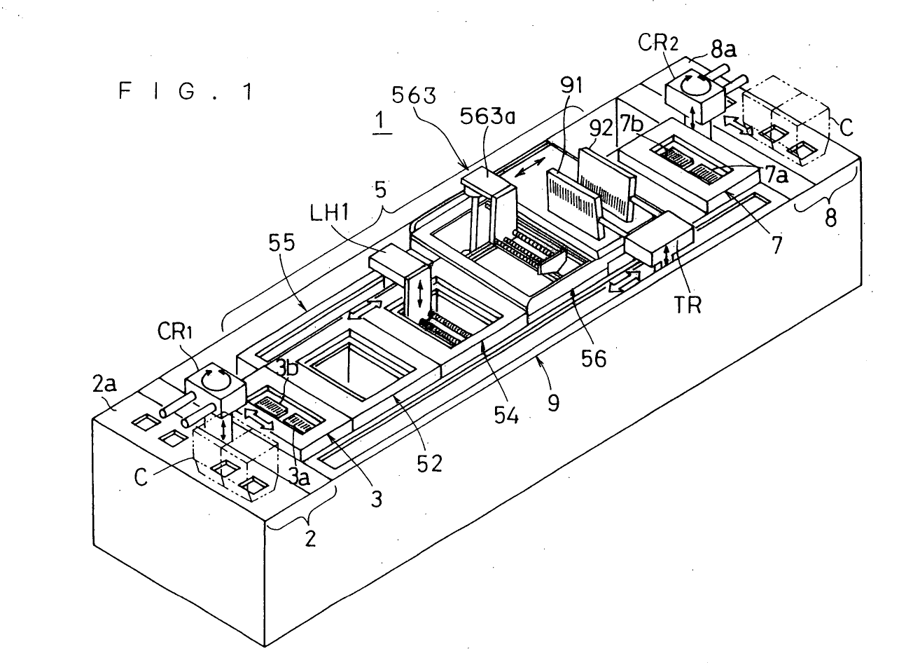

A general arrangement of a substrate processing apparatus 1 containing a multifunctional processing part 56 will now be described. FIG. 1 is a perspective view showing a general arrangement of the substrate processing apparatus 1.

The substrate processing apparatus 1 is equipped with a loading part 2 that loads a cassette C storing untreated substrates; a takeout part 3 that places a loaded cassette C and takes out substrates from the cassette C; a processing part 5 that performs substrate processing such as cleaning; a housing part 7 that houses treated substrates in a cassette C; and an unloading part 8 that unloads a cassette C containing treated substrates. Disposed on the front side of the substrate processing apparatus 1 (the right hand side in the direction to transport substrates) is a transport mechanism 9 along the takeout part 3, the processing part 5, and the housing part 7. The transport mechanism 9 has a traverse movement while causing a pair of rotatable hands 91 and 92 to grip substrates, thereby transporting substrates among the takeout part 3, the processing part 5 and the housing part 7.

The loading part 2 has a cassette transfer robot CR1. The cassette transfer robot CR1 has horizontal movement, up and down movements, and rotary motion about the vertical axis, so that a cassette C placed on a cassette stage 2a can be moved to the takeout part 3.

The takeout part 3 has a pair of holders 3a and 3b that move up and down. A guide groove is provided in an upper surface of the holders 3a and 3b, respectively. A plurality of substrates in a cassette C are supported in an upright position on the guide grooves of the holders 3a and 3b. The top and bottom surfaces of each substrate are parallel to the direction to transport substrates. A cassette C is placed on the takeout part 3, and substrates are taken out of the cassette C when the holder 3a or 3b moves up. The substrates taken out of the cassette C are transferred to the transport robot TR of the transport mechanism 9, and transported to the processing part 5.

The processing part 5 has a chemical processing part 52 equipped with a chemical tank, a water-washing processing part 54 equipped with a water-washing tank, and a multifunctional processing part 56. A lifter 55 is disposed behind the chemical processing part 52 and the water-washing processing part 54. The lifter 55 has a lifter head LH1 that can move longitudinally and laterally. The lifter 55 immerses the substrates received from the transport robot TR in the chemical tank and then in the water-washing tank by having them move between the chemical processing part 52 and the water-washing processing part 54. A lifter 563 is disposed at the multifunctional processing part 56. The lifter 563 is equipped with a lifter head 563a that can move up and down. The lifter 563 has the substrates received from the transport robot TR move up and down within the multifunctional processing part 56.

Like the takeout part 3, the housing part 7 has a pair of holders 7a and 7b that move up and down. The housing part 7 receives treated substrates from the transport robot TR, and houses them in a cassette C.

Like the loading part 2, the unloading part 8 has a cassette transfer robot CR2 that has horizontal movement, up and down movement, and rotary motion about the vertical axis. The cassette transfer robot CR2 transfers the cassette C placed on the housing part 7 to a cassette stage 8a.

<2. Construction of Multifunctional Processing Part 56>

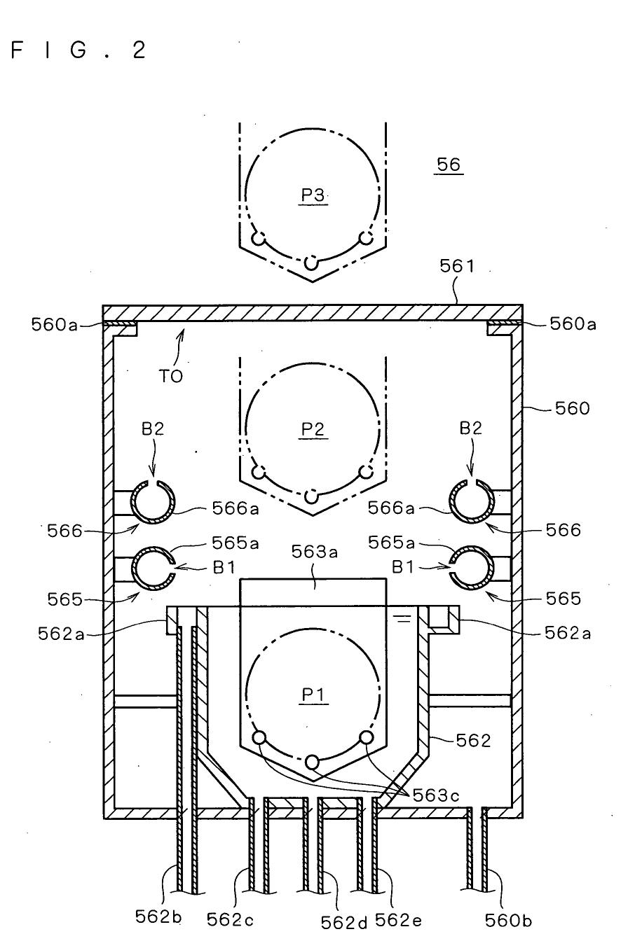

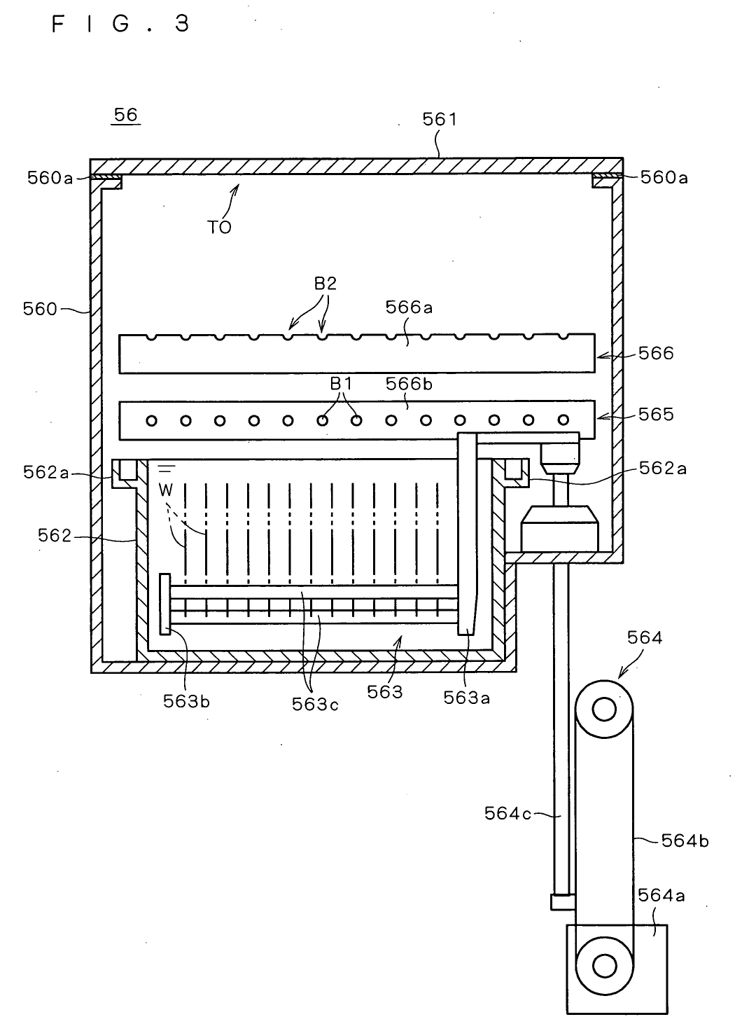

A detailed construction of the multifunctional processing part 56 will next be described. FIG. 2 is a longitudinal section of the multifunctional processing part 56, the section being taken along the plane parallel to substrates W. FIG. 3 is a longitudinal section of the multifunctional processing part 56, the section being taken along the plane perpendicular to the substrates W.

As shown in FIGS. 2 to 3, the multifunctional processing part 56 comprises mainly a casing 560, a shutter 561, a processing tank 562, a lifter 563, a lifter driving part 564, a first gas-discharge part 565, and a second gas-discharge part 566.

The casing 560 has a substrate gate TO on its upper surface, and an exhaust pipe 560b on its bottom surface. A seal member 560a is adhered to around the periphery of the substrate gate TO. Therefore, when the shutter 561 is closed, the casing 560 is hermetically sealed.

With a driving mechanism having a rail, a motor and the like (not shown), the shutter 561 has slide movement for opening and closing the substrate gate TO.

The processing tank 562 stores hydrofluoric acid or deionized water. The multifunctional processing part 56 performs etching and cleaning processing by immersing the substrates W in such liquid stored in the processing tank 562. An outer tank 562a is disposed at an upper end of the outer side of the processing tank 562. The liquid overflowing from the processing tank 562 runs into the outer tank 562a, and is recovered into a recovery pipe 562b. A pipe 562c that returns the liquid recovered by the pipe 562b to the processing tank 562, a pipe 562d that speedily discharges the liquid within the processing tank 562, and a pipe 562e that supplies liquid to the processing tank 562 are connected to the bottom of the processing tank 562.

The lifter 563 has three holding bars 563c between the lifter head 563a and a holding plate 563b. Each of the holding bars 563c has a number of holding grooves (not shown). The substrates W can be held on these holding grooves.

The lifter driving part 564 is equipped with a servo motor 564a, a timing belt 564b, and a shaft 564c. The timing belt 564b is connected to the servo motor 564a, and executes rotary motion under the drive of the servo motor 564a. The shaft 564c is connected at its lower end to the timing belt 564b, and at its upper end to the lifter head 563a. Accordingly, when the servo motor 564a is driven, the lifter 563 moves up and down via the timing belt 564b and the shaft 564c.

Up and down movements of the lifter 563 enables the substrates W to move among an immersion position P1 within the processing tank 562, a drying position P2 above the processing tank 562, and a delivery position P3 above the casing 560. In other words, the lifter 563 has the function of lifting the substrates W from the immersion position P1.

The first gas-discharge part 565 has two gas-discharge pipes 565a. The two gas-discharge pipes 565a are respectively attached via a bracket to the inner surface of the casing 560. The two gas-discharge pipes 565a is provided with a plurality of gas-discharge ports B1, through which gas is discharged horizontally to the inside of the casing 560. The gas-discharge pipes 565a are attached to a position slightly higher than the upper surface of the processing tank 562 (i.e., a liquid level when the processing tank 562 is filled with liquid), such that they discharge gas toward a path to lift the substrates W. When the substrates W are lifted, the gas-discharge pipes 565a blow gas directly on the substrates W, particularly, on the contact area between the peripheral portions of the substrates W and the holding bars 563c.

The second gas-discharge part 566 is also provided with two gas-discharge pipes 566a. The two gas-discharge pipes 566a are attached to the inner side of the casing 560 such that they are located slightly above the gas-discharge pipes 565a. Each of the two gas-discharge pipes 566a has a plurality of gas-discharge ports B2, through which gas is discharged vertically to the upper space of the casing 560.

FIG. 4 is a diagram showing the construction of pipes involved in the multifunctional processing part 56. A three-way valve V1, a pump P and a filter F are interposed in the pipe 562b. A pipe 562c is connected to the downstream side of the pipe 562b. A pipe 562bc is connected to the other port of the three-way valve V1. The pipe 562bc and a pipe 562d join together, and a valve V2 is interposed in the joined pipe. In this construction, controlling the three-way valve V1 permits switching between a state in which the processing liquid overflowing from the processing tank 562 is discharged to a drain line, and a state in which the processing liquid overflowing from the processing tank 562 is filtered and returned to the processing tank 562.

A pipe 562e branches into two pipes, one of which is connected via the valve V3 to a HF supply source 567b, and the other is connected via a valve V4 to a deionized water supply source 567c. Hence, controlling the valves V3 and V4 enables HF and deionized water to be selectively supplied to the processing tank 562.

The pipe 560b is connected via a valve V5 and an air pump AP to an exhaust line within the facility. Therefore, when the air pump AP is operated with the valve V5 opened, the atmosphere within the casing 560 is exhausted, and the interior of the casing 560 is depressurized.

A pipe 565c is connected to the gas-discharge pipe 565a of the first gas-discharge part 565. The other end of the pipe 565c is connected to a gas supply source 567d, and a valve V6 is interposed in the pipe 565c. A pipe 566c is connected to the gas-discharge pipes 566a of the second gas-discharge part 566. The other end of the pipe 566c is connected to a gas supply source 567d, and a valve V7 is interposed in the pipe 565c. Therefore, controlling the valves V6 and V7 enables gas to be supplied from the gas supply source 567d to either or both of the gas-discharge pipes 565a and 566a. This enables gas to be blown from either or both of the gas-discharge pipes 565a and 566a into the casing 560.

The gas supply source 567d supplies nitrogen gas from a nitrogen supply source S1 through two types of paths. An IPA supply source S2 is interposed in one path. Upon selection of this path, IPA vapor is supplied together with nitrogen gas. One of the two paths can be selected by controlling valves V8, V9 and V10, which are interposed in the pipe of the gas supply source 567d.

The IPA supply source S2 heats liquid IPA by the heat of a heater H1, thereby generating IPA vapor. Therefore, controlling the strength of the heater H1 changes the concentration of IPA vapor contained in nitrogen gas that becomes carrier gas.

A heater H2 for heating nitrogen gas is interposed between the nitrogen supply source S1 and the branch point of the two paths. Placing the heater H2 in operation heats nitrogen gas to be supplied into the casing 560. The nitrogen gas supplied from the nitrogen supply source S1 is dry gas free from water vapor.

The multifunctional processing part 56 is also provided with a control part 567a. The control part 567a is electrically connected to the above-mentioned three-way valve V1, the valves V2 to V10, the pump P, the air pump AP, the filter F, and the heaters H1 and H2, thereby controlling the operations of these.

<3. Procedure in Multifunctional Processing Part 56>

The procedure in the multifunctional processing part 56 will next be described. The multifunctional processing part 56 performs etching processing with hydrofluoric acid, water-washing processing, and drying processing. The flow of the steps from water-washing processing to drying processing that are carried out after etching processing will be discussed below. Substrates to be processed are previously subjected to resist-coating processing by other apparatus, so that they are hydrophilic substrates having a resist on their surfaces.

The following processing progresses by control of the three-way valve V1, the valves V1 to V10, the pump P, the air pump AP, the filter F, and the heaters H1 and H2, each of which is exercised by the control part 567a.

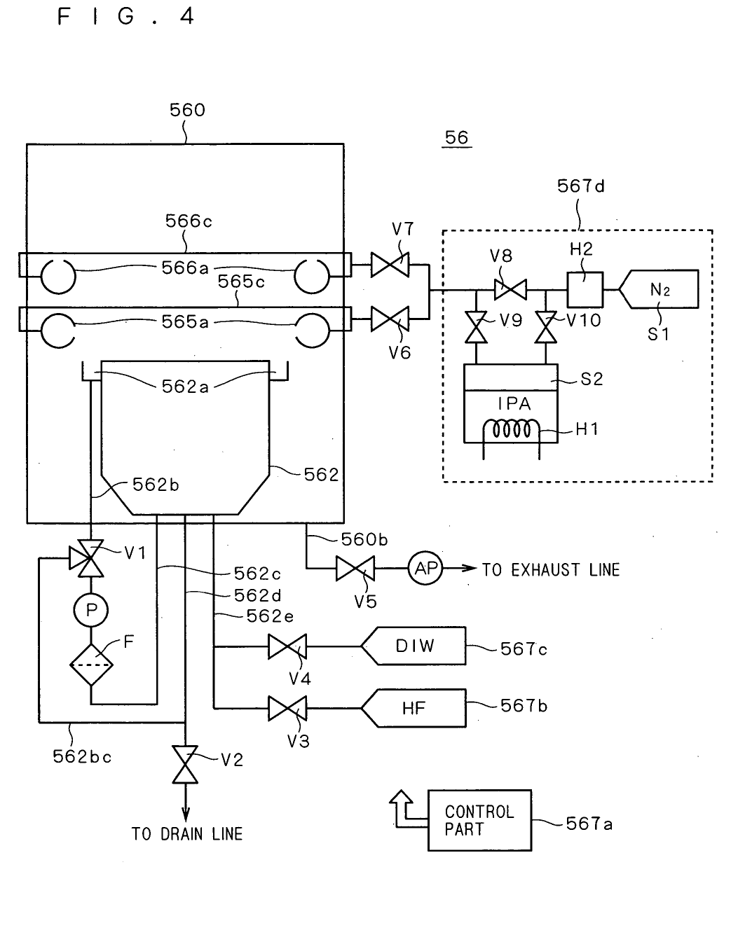

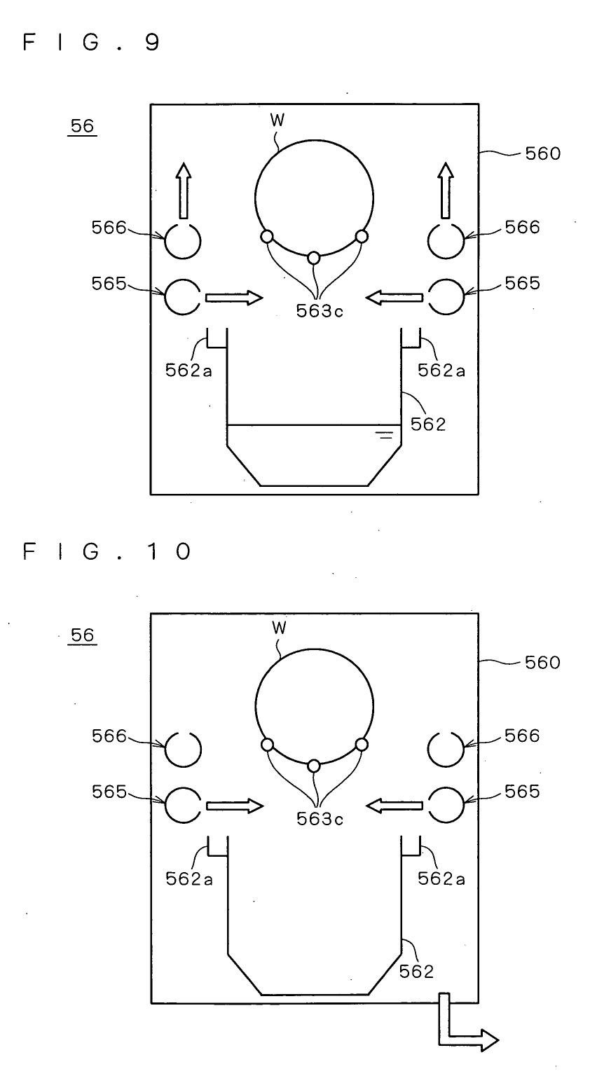

FIGS. 5 to 10 are diagrams showing processing situations at individual stages in the multifunctional processing part 56. In these diagrams, white arrows indicate discharge of nitrogen gas, and hatched arrows indicate discharge of IPA vapor and nitrogen gas.

Referring to FIG. 5, substrates W are first immersed in the processing tank 562, and are subjected to water-washing processing with deionized water. Deionized water is supplied from the bottom of the processing tank 562, and it overflows the upper part of the processing tank 562, and flows down the outer tank 562a to the pipe 562b (see FIG. 4). The deionized water is then filtered and returned via the pipe 562c (see FIG. 4) to the processing tank 562.

At this time, the first and second gas-discharge parts 565 and 566 discharge nitrogen gas, so that the air within the casing 560 can be replaced with nitrogen gas. The first gas-discharge part 565 discharges nitrogen gas toward the central space of the casing 560, that is, toward the path to lift the substrates W. The second gas-discharge part 566 discharges nitrogen gas toward the upper space of the casing 560. As a result, the air within the casing 560 can be replaced with nitrogen gas in upper-to-lower order, and then exhausted efficiently to the pipe 560b on the bottom (see FIG. 4). Since both of the gas-discharge parts 565 and 566 discharge nitrogen gas, much nitrogen gas can be supplied per unit time, thereby enabling the whole interior of the casing 560 to be speedily filled with nitrogen gas.

Thus, the interior of the casing 560 can be filled with nitrogen gas during water-washing processing. This suppresses poor drying in the subsequent drying processing. In particular, the elimination of oxygen from the interior of the casing 560 can suppress the occurrence of watermarks on the surfaces of the substrates W. In addition, the elimination of vapor from the interior of the casing 560 can shorten drying times of the substrates W.

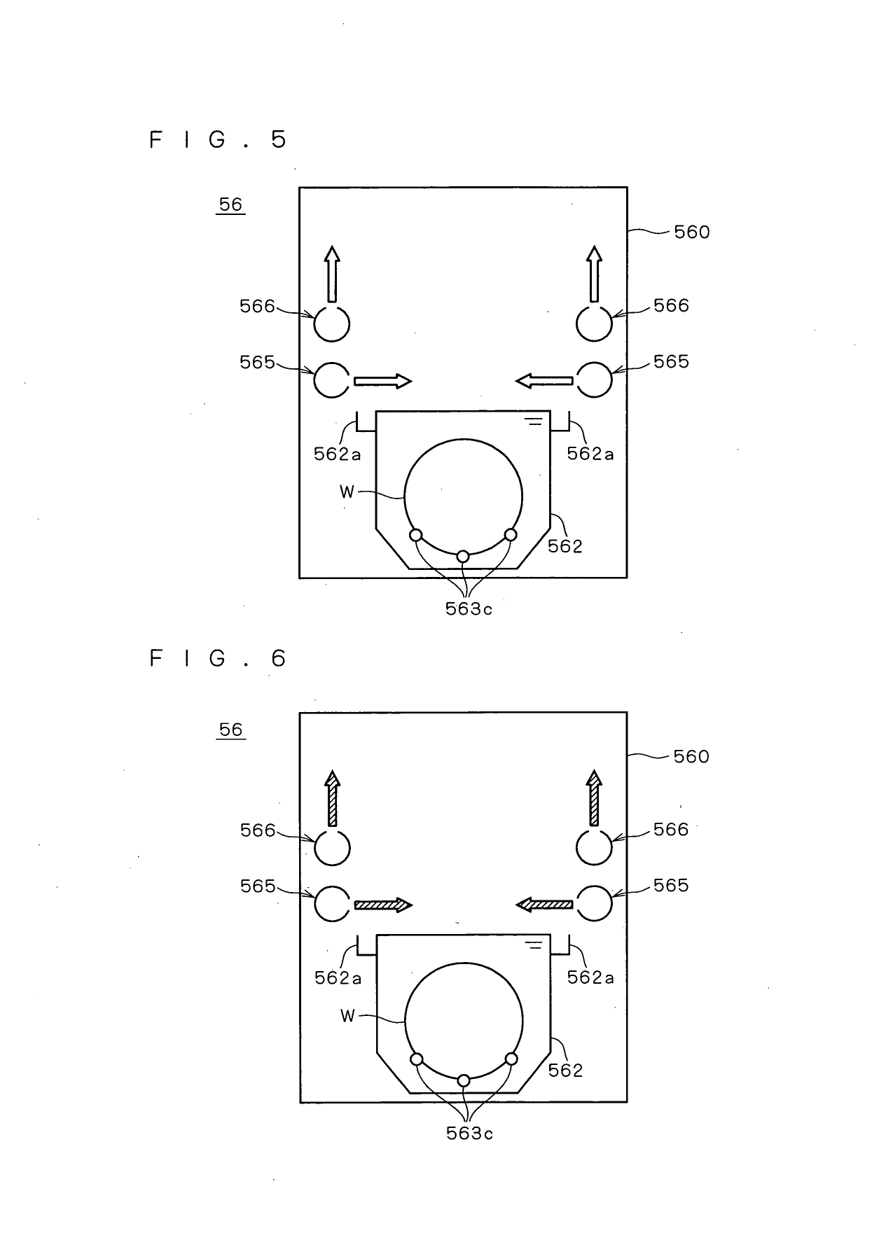

When the interior of the casing 560 is filled with nitrogen gas, the valve V8 of the gas supply source 567d (see FIG. 4) is closed, and the valves V9 and V10 are opened to discharge IPA vapor from the first and second gas-discharge parts 565 and 566, as shown in FIG. 6. As a result, the interior of the casing 560 is brought into a state in which IPA vapor is contained in the atmosphere of nitrogen gas. Since both of the first and second gas-discharge parts 565 and 566 discharge IPA vapor, IPA vapor can be supplied efficiently into the casing 560.

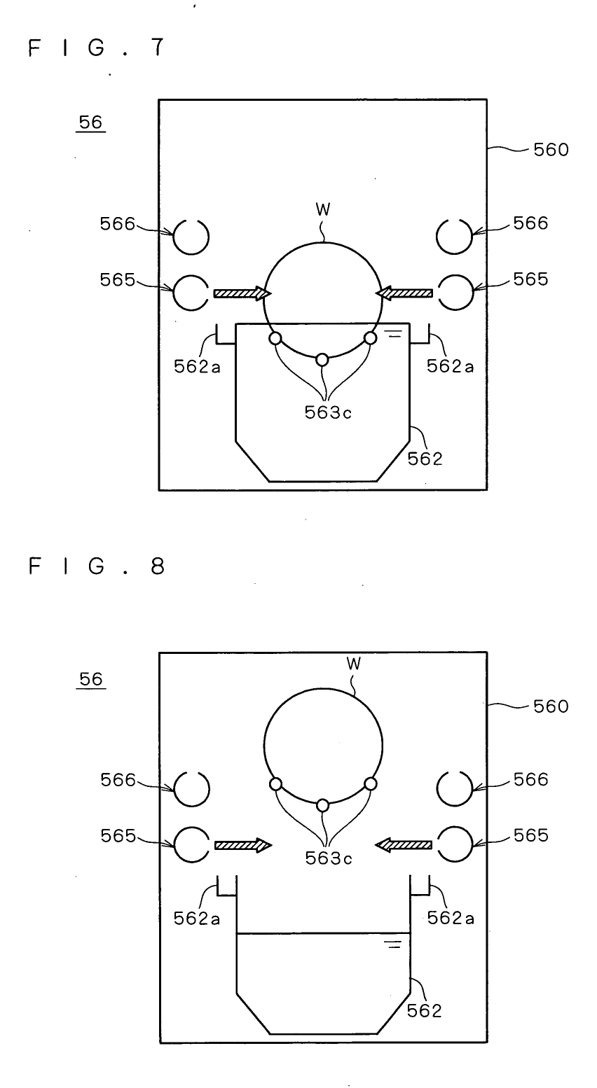

When sufficient IPA vapor is supplied into the casing 560, the lifter driving part 564 (see FIG. 3) is driven such that the lifter 563 holding the substrates W can be lifted from the processing tank 562, as shown in FIG. 7. Hereat, the first gas-discharge part 565 continues to discharge IPA vapor. The discharge direction of the first gas-discharge part 565 is toward the path to lift the substrates W, so that IPA vapor can be blown directly on the substrates W that are being lifted. The blown IPA vapor condenses on the surfaces of the substrates W, and vaporizes together with deionized water.

In this processing, the IPA vapor is directly blown on the substrates W, allowing the IPA vapor to condense efficiently on the surfaces of the substrates W. Therefore, if the concentration of IPA vapor supplied is low, a sufficient amount of IPA condenses on the surfaces of the substrates W, thus causing no drying performance deterioration. Furthermore, lowering the concentration of IPA vapor can suppress dissolution of a resist formed on the surfaces of the substrates W.

Along with IPA vapor, nitrogen gas as carrier gas is also blown on the substrates W that are being lifted from deionized water. When nitrogen gas that is dry gas is directly blown on the substrates W, the IPA and deionized water attached to the surfaces of the substrates W can speedily vaporize. This reduces a period of time that IPA condensing on the surfaces of the substrates W stays there. Accordingly, the dissolution of a resist can be further suppressed. If the heater H2 (see FIG. 4) is operated to supply heated nitrogen gas, thermal energy can be stored in the substrates W, thereby further facilitating vaporization of IPA and deionized water.

Moreover, since gas is directly blown on the substrates W, the deionized water attached to the surfaces of the substrates W can be blown off and removed by the gas. In particular, the gas is blown directly on the contact area between the substrates W and the holding bars 563c, from which it is difficult to remove deionized water. Hence, the droplets attached to the contact area between the substrates W and the holding bars 563 can be blown off or vaporized and removed.

Preferably, the gas-discharge amount from the first gas-discharge part in lifting the substrates W is increased than that in immersing the substrates W. This further facilitates the condensation of IPA, the vaporization of IPA and deionized water, and the blow-off of droplets, as described above.

When lifting the substrates W, the discharge of IPA vapor from the second gas-discharge part 566 may be continued or stopped. Since ample IPA vapor is already supplied to the upper space of the casing 560, it is desirable to stop the discharge of IPA vapor from the second gas-discharge part 566, from the point of view of IPA consumption savings.

When the lift of the substrates W is completed, the valve V2 (see FIG. 4) is opened to start the drain of deionized water from the processing tank 562, as shown in FIG. 8. Hereat, the first gas-discharge part 565 continues to discharge IPA vapor. In so doing, the droplets on the surfaces of the substrates W, which could not be removed during lifting, can be replaced with IPA.

After an elapse of a predetermined period of time, the valves V9 and V10 (see FIG. 4) are closed, and the valves V7 and V8 (see FIG. 4) are opened to discharge nitrogen gas from the first and second gas-discharge parts 565 and 566, thereby vaporizing the IPA and deionized water remaining on the surfaces of the substrates W. Additionally, IPA and vapor can be removed from the interior of the casing 560. Hereat, both of the first and second gas-discharge parts 565 and 566 discharge nitrogen gas, allowing IPA and deionized water to speedily vaporize.

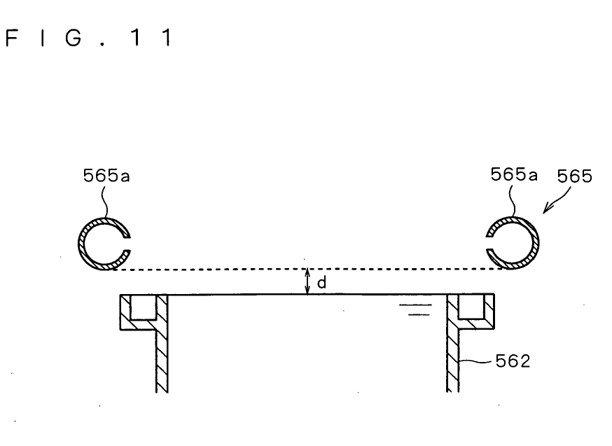

When the interior of the casing 560 is again filled with nitrogen gas, the valve V7 (see FIG. 4) is closed to stop the discharge of nitrogen gas from the second gas-discharge part 566, as shown in FIG. 10. Then, the air pump AP (see FIG. 4) is operated so as to forcedly exhaust the atmosphere within the casing 560. Since the interior of the casing 560 is depressurized, the deionized water remaining on the surfaces of the substrates W vaporizes completely to dry the substrates W.

Finally, the shutter 561 is opened, allowing the interior of the casing 560 to bleed to atmosphere. Then, the lifter 563 moves up to the delivery position P3 (see FIG. 2), thereby taking the substrates W out of the casing 560. Thus, a series of processing in the multifunctional processing part 56 have now been finalized.

As above described, in the multifunctional processing part 56, IPA vapor is directly blown on the substrates W that are being lifted from deionized water, so that the IPA vapor can condense efficiently on the surfaces of the substrates W. This makes it possible to lower the concentration of IPA vapor supplied, thereby preventing dissolution of a resist on the surfaces of the substrates W.

Further, along with IPA vapor, nitrogen gas as carrier gas is blown on the substrates W, allowing IPA and deionized water to speedily vaporize. This reduces a period of time that IPA condensing on the substrates W stays there, thereby preventing dissolution of the resist.

Before the substrates W are lifted from deionized water, nitrogen gas is sufficiently supplied into the casing 560, so that the oxygen and water vapor within the casing 560 can be previously removed. Hence, after the substrates W are lifted from deionized water, the drying processing of the substrates W can be speedily completed. This prevents dissolution of the resist, and also suppresses occurrence of poor drying such as watermarks.

Although IPA is used as organic solvent in the foregoing example, other organic solvents such as ethanol and methanol may be used. Although nitrogen gas is used as inert gas, other inert gases such as helium gas and argon gas may be used.

Although the second gas-discharge part 566 discharges gas toward immediately above in the foregoing example, it may not be precisely immediately above. The second gas-discharge part 566 may discharge gas toward the upper space of the casing 560.

Although the first gas-discharge part 565 discharges gas horizontally to the inside of the casing 560 in the foregoing example, it may not be precisely horizontal. That is, the first gas-discharge part 565 may discharge gas toward the path to lift the substrates W. For example, the first gas-discharge part 565 may discharge gas slightly upwardly than horizontally.

In cases where both of bare Si and SiO₂ are present on the surfaces of substrates W to be processed, attention should be given to the fixing height of the gas-discharge pipe 565a of the first gas-discharge part 565. If the fixing height of the gas-discharge pipe 565a is too low, during the processing, material composed of SiO₂ attaches to the area of the bare Si on the substrates W, resulting in a defect. It can be considered that the cause of this defect is disturbance of the liquid surface of the processing tank 562 due to IPA vapor discharged from the gas-discharge pipe 565a. To prevent this defect, it is desirable that the distance (distance d shown in FIG. 11) between the upper surface of the processing tank 562 (a liquid surface when the processing tank 562 is filled with liquid) and the gas-discharge pipe 565a be spaced at least 55 mm or more.

While the invention has been shown and described in detail, the foregoing description is in all aspects illustrative and not restrictive. It is therefore understood that numerous modifications and variations can be devised without departing from the scope of the invention.

What is claimed is:

1. A substrate processing method that performs substrate cleaning and drying in the interior of a processing chamber, comprises the steps of:
(a) admitting inert gas to a central space and an upper space within the processing chamber, while immersing a substrate in deionized water stored in a processing tank; and
(b) blowing organic solvent vapor on a substrate, while lifting a substrate from deionized water.

2. The substrate processing method according to claim 1, wherein in the step (b), organic solvent vapor is blown on a substrate from the right and left of a substrate.

3. The substrate processing method according to claim 2, wherein in the step (b), organic solvent vapor is blown along with inert gas.

4. The substrate processing method according to claim 3, wherein in the step (b), organic solvent vapor is blown directly on a contact area between a substrate and a holding member for holding a substrate.

5. The substrate processing method according to claim 4, wherein inert gas blown in the step (b) is heated inert gas.

6. The substrate processing method according to claim 5, wherein a larger amount of gas is discharged in the step (b) than in the step (a).

7. The substrate processing method according to claim 6, further comprising the step of:
(c) discharging inert gas toward a central space and an upper space of the processing chamber after the step (b).

8. The substrate processing method according to claim 7, further comprising the step of:
(d) depressurizing the processing chamber after the step (c).

9. A substrate processing apparatus that performs substrate cleaning and drying in the interior of a processing chamber, comprising:
a processing tank that stores deionized water;
a lifter that immerses a substrate in deionized water stored in the processing tank, and also lifts a substrate from deionized water;
a first discharge part that discharges organic solvent vapor after discharging inert gas, toward a central space within the processing tank; and
a second discharge part that discharge inert gas toward an upper space within the processing tank.

10. The substrate processing apparatus according to claim 9, further comprising:
a control part that controls so as to discharge inert gas from the first discharge part and the second discharge part, while immersing a substrate in deionized water stored in the processing tank, and then discharge organic solvent vapor from the first discharge part, while lifting a substrate from deionized water.

11. The substrate processing apparatus according to claim 10, wherein the first discharge part discharges organic solvent vapor toward a path through which the lifter lifts a substrate.

12. The substrate processing apparatus according to claim 11, wherein the first discharge part discharges organic solvent vapor along with inert gas.

13. The substrate processing apparatus according to claim 12, wherein
the lifter has a holding member that holds a substrate through partial contact; and
the first discharge part blows organic solvent vapor directly on a contact area between a substrate in the course of lifting and the holding member.

14. The substrate processing apparatus according to claim 13, further comprising:
a heating part that heats inert gas discharged from the first discharge part.

15. The substrate processing apparatus according to claim 14, further comprising:
a depressurizing part that depressurizes the interior of the processing chamber.

16. The substrate processing apparatus according to claim 15, further comprising:
a concentration adjusting part that adjusts the concentration of organic solvent discharged from the first discharge part.

17. The substrate processing apparatus according to claim 16, wherein the first discharge part is located above 55 mm or more from the upper surface of the processing tank.
